(19) United States
(12) Patent Application Publication
(10) Pub. No.: US 2012/0271822 A1
(43) Pub. Date: Oct. 25, 2012

(54) SYSTEM FOR ESTABLISHING PREFERRED CONTACTS FOR A CENTRAL USER OF A MOBILE COMMUNICATION DEVICE

(75) Inventors: Lauren E. Schwendimann, Chicago, IL (US); Johnny C. Chen, San Jose, CA (US); Alan J. Chou, Campbell, CA (US); Nathan J. Fortin, Morgan Hill, CA (US)

(73) Assignee: MOTOROLA MOBILITY, INC., Libertyville, IL (US)

(21) Appl. No.: 13/093,255

(22) Filed: Apr. 25, 2011

(51) Int. Cl. G06F 17/30

(52) U.S. Cl. 707/736; 707/E17.001

(57) ABSTRACT

A system is implemented on a mobile communication device for establishing preferred contacts for a central user of the mobile communication device. The system comprises a data collection device that captures the central user's interaction with other users on a network according to frequency during situational factors; and a query apparatus that inquires, for current situational factors, which contacts are preferred that the central user will communicate with based on central user's past interactions during same situational factors that correspond only to the central user. A list is provided to the central user of one or more of the preferred contacts that the central user selects from; and an application launcher is communicatively coupled to the list for display of the list of preferred contacts that are also functionally related to the application launcher.

### FIELD OF INVENTION

The present invention relates generally to inferring and suggesting preferred contacts for a mobile communication device user. More particularly, the present invention creates a collection of preferred contacts who may be unrelated to one another, but who are most important or have higher priority to a central user when certain situational factors exist, and because the central user interacts frequently with each contact individually while the situational factors remain active.

### BACKGROUND OF THE INVENTION

In the age of nearly ubiquitous use of mobile communication devices or mobile computing devices (MCDs) that store large amounts of contact information such as names, addresses, email addresses, phone numbers, and miscellaneous notes for perhaps several hundred people in a MCD user's life, the amount of data may be overwhelming to manage and search when a need arises to find the proper contact at the proper time while in a specific location.

### BRIEF DESCRIPTION OF THE DRAWINGS

FIG. 1 is an exemplary block diagram of a rule-based system that will provide suggestions for preferred contacts.

FIG. 2 is an exemplary overall system that incorporates current situations for a central user of a mobile communication device.

FIG. 3 is an exemplary flowchart depicting a method for determining the most likely set of contacts for a central user at a particular time, otherwise termed “smart contacts”.

FIG. 4A is an exemplary screenshot of a global preferred contacts display for the favorites tab on a display for a mobile communication device.

FIG. 4B is an exemplary screenshot of several smart contacts that may be employed across multiple mobile communication device applications.

FIG. 5 is an exemplary screenshot of a texting mobile communication device application that has corresponding preferred contacts as recipients.

FIG. 6 is an exemplary screenshot of a global preferred contacts display for the contacts tab on a display for a mobile communication device.

FIG. 7 is an exemplary screenshot of an emailing mobile communication device application that has corresponding preferred contacts as recipients.

FIG. 8 is an exemplary screenshot of a social media networking mobile communication device application that has corresponding preferred contacts as recipients.

### DETAILED DESCRIPTION

A system implemented on a mobile communication device (MCD) for establishing preferred contacts for a central user of the mobile communication device can include a data collection device that captures the central user's interaction with other users on a network according to frequency during situational factors; and a query apparatus that inquires, for current situational factors, which contacts are preferred that the central user will communicate with based on central user's past interactions during same situational factors that correspond only to the central user. Subsequently, a list is provided to the central user of one or more of the preferred contacts that the central user selects from and an application launcher is provided that is communicatively coupled to the list for displaying the list of preferred contacts that are also functionally related to the application launcher. The preferred contacts can be high priority people in relation to the central user based on individual communication patterns and context for the communication, for example, time, location, and proximity to the central user.\

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Before describing in detail embodiments that are in accordance with the present invention, it should be observed that the embodiments reside primarily in combinations of method steps and device components related to associating objects in an electronic device. Accordingly, the device components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the method, or device that comprises the element. Also, throughout this specification the term “key” has the broad meaning of any key, button or actuator having a dedicated, variable or programmable function that is actuatable by a user.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions, and the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

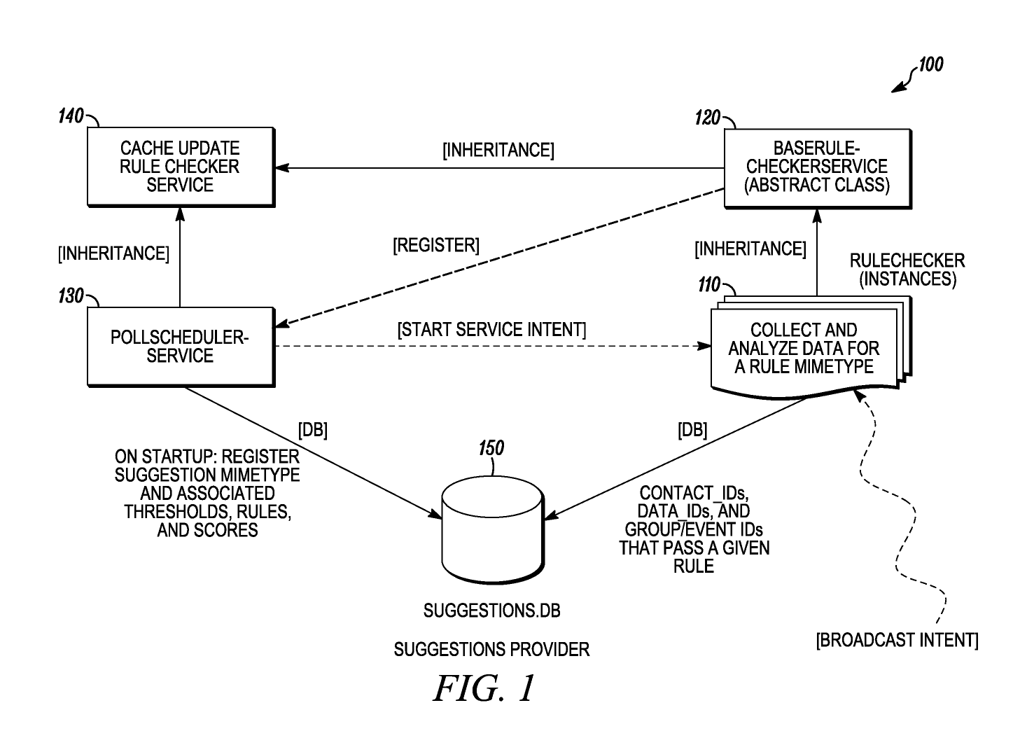

Referring to FIG. 1, an exemplary system 100 is illustrated that will provide suggestions for preferred contacts. A suggestion may include a prediction of relevant contacts based on the aggregate results of rules that operate upon a given set of contextual data. A suggestion is valid, if the aggregation (sum) of the scores all applicable rules that pass meets or exceeds a given threshold value. The exemplary system 100 includes a data collection device 110 that captures the central user's interaction with other users on a network (not shown) according to frequency during situational factors. The collection and analysis of data by data collection device 100 can be according to various rules, such as a rule MIMEtype. In general a rule may be a transformation or computational test of data that evaluates into a pass or fail result.

The rules are further examined in system 100 by a Base Rule Checker Service 120 that looks at specific instances, assigns an inheritance value, and may either poll Data and/or react to Broadcast events, while respecting a minimum wait time interval requirement between computations. The Rule Checker can be a service that collects data, evaluates a rule based on that data, and records the relevant results of such rule processing. It may use a data polling strategy and/or be event-based with the requirement that a specified minimum amount of time has elapsed between computation cycles.

The Rule Checker may comprise the following steps:

(1) TRIGGER: The polling interval expires or a relevant Broadcast event occurs.
(2) DELAY: Defer actual execution until after the minimum wait time interval requirement has been met.

### (3) COLLECT Data.

(4) EVALUATE Rule based on collected Data.
(5) CLEAR the Suggestions ContentProvider of all old data associated with this Rule MIMEtype.
(6) WRITE new results (Contact_IDs that “Pass” the Rule) to the Suggestions ContentProvider.

One or more instance of a Rule Checker inherits from a superclass BaseRuleChecker, which provides a supporting framework and interface for such common functional requirements. Notably, a Rule Checker that is killed can recover immediately. Additionally, the Base Rule Checker service 120 can, in conjunction with a new arbiter component (not currently implemented), enforce a policy that only one Rule Checker may be running at any given moment in time. This would in effect guarantee a limit for the peak CPU and memory usage of a Suggestions Rule Checker system. If a token ring network arbiter architecture is chosen, then a watchdog timer may be necessary to recover from Rule Checkers that do not properly signal their completion, due to software hazards such as infinite loops, deadlocks, livelocks, crashes, and arbitrary killings by an operating system. The base rule checker service registers rules, scores, and thresholds for use by a poll scheduler service 130. Registration and polling is coordinated by the Poll Scheduler Service 130.

For Poll Scheduler Service 130 in system 100 a suggestion is defined by a threshold score and a set of Rule MIMEtypes and the scores associated with each Rule MIMEtype that “Passes” the test. The Poll Scheduler Service 130 may employ a SuggestionRegistrar to define these configuration values, but an XML file, Flex, a user-interface activity, or other dynamic post-compile configuration systems could also be employed. In one embodiment, every suggestion provides its own custom “negative feedback” or “thumbs down” Rule MIMEtype and assigns it an appropriate negative Score, such as an Integer.MIN_VALUE.

At start-up, the Poll Scheduler Service 130 is initially launched by a startService Intent “ACTION_START_SCHEDULER”. After initialization, it sends Broadcast Intent “ACTION_SCHEDULER_STARTED” to notify all Rule Checkers that it is ready to accept registrations via startService Intent “ACTION_REGISTER_SERVICE”.

After a Rule Checker service is registered, it will receive exactly one request to check its Rule data after a minimum post-registration wait time interval has elapsed. For example, a Rule Checker may be launched via startService Intent “ACTION_RULE_CHECK_X”, where “X” is descriptive of the Rule data that will be checked. The minimum post-registration wait time interval is a universal constant for all Rule Checker registrations, and allows a Suggestions engine to minimize its impact on the mobile communication device's startup performance by deferring actual rule processing until the operating system has fully initialized most of its startup components and settled down.

Another universal scheduler delay constant is the minimum time delay between subsequent Rule Checker launches. This delay helps to probabilistically reduce the Suggestions engine's performance impact on the operating system during normal operations by allowing one Rule Checker some lead-off time to potentially complete most or all of its operations before a subsequent Rule Checker is launched. However, it does not guarantee that at most one Rule Checker service is executing.

Also within system 100 is a cache update rule checker service 140 that leverages the Base Rule Checker Service 120 to enforce timings for recalculation and update of cached contacts and data suggestions results in a Suggestions ContentProvider 150. Note that it does not actually check a proper “Rule” or collect data for any particular “Rule” whatsoever. The startService Intent “ACTION_RULE_CHECK_CACHE_UPDATE” requests that the Suggestions ContentProvider's cached contacts and data suggestions be updated at the next earliest opportunity. Also, the generic startService Intent “ACTION_UPDATE_CACHED_SUGGESTIONS” is handled via the same way as an internal Handler thread Message dispatch, as the specialized startService Intent “ACTION_RULE_CHECK_CACHE_UPDATE”.

In one embodiment, “ACTION_UPDATE_CACHED_SUGGESTIONS” is can be a generic Intent for general use, and otherwise “ACTION_RULE_CHECK_CACHE_UPDATE” can be the specialized PollSchedulerService Intent. Thus, even though they may yield identical results, their exact functionalities may diverge at any time in the future.

Suggestions Content Provider database 150 stores the positive results of the Rule Checkers and caches the Suggestion results based on the sum of the configured rule cores that pass and the configured thresholds for each suggestion. A threshold is defined as a level in which a contact is declared to be a valid suggestion when the aggregation of the scores of all rules that pass for the given suggestion meets or exceeds a predetermined value.

In one embodiment, the preferred contacts that are suggested may be defined and referred to as suggested contacts, emergent contacts, inferred contacts, smart contacts, or likely contacts, for example. These terms are used interchangeably herein.

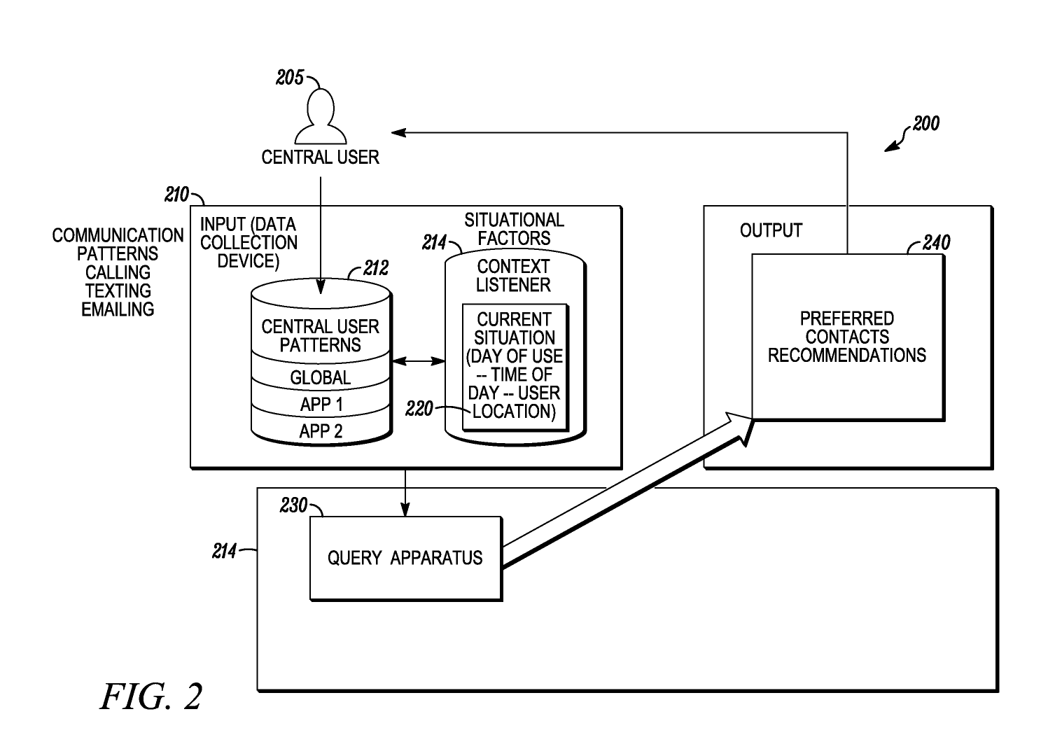

An exemplary system 200, in FIG. 2, shows that a central user 205 will have or provide communication pattern data that will be useful as input to a data collection device 210. The data collection device can include a central user pattern database 212 and a context listener database 214. The central user pattern database 212 captures communication patterns related to global interactions with a plurality of contacts and specific interactions within specific applications. For example, a central user may communicate with 10 different contacts during an elapsed time period. The global data will reflect those 10 different contacts; whereas, the specific application data, i.e., app 1 and app 2 will include data that is a subset of the 10 different contacts that are related to the specific communication method associated with either app 1 or app 2. That is app 1 can be a texting application and will have 3 contacts (and their associated data) that were communicated with via texting. Whereas, app 2 may have 5 contacts (and their associated data) that were communicated with via emailing.

The context listener database 214 may be electronically coupled to the central user pattern database. The context listener database 214 includes a plurality of situational factors that can be relevant to determining the central users communication patterns. For example the context listener captures data from the central user that is indicative of time of day, user location, day of week, seasonal period, and proximity distance to other relevant mobile communication device users or other electronic devices such as printers, televisions, monitors, or displays, and an electronic calendar of the central user.
The context listener database 214 receives current situational information 220 for comparison and use by a query apparatus 230. The current situational information 220 can reside internally within the context listener database 214 or reside externally to context listener database 214.

The query apparatus 230 inquires, for current situational factors (i.e., current situation information 220), which contacts are preferred that the central user will communicate with based on central user's past interactions during same situational factors that correspond only to the central user.

A graphical display of preferred contact recommendations 240 (that can be a drop down list or a set of thumbnail images) is derived from the query apparatus 230 and provided to the central user for selection. The collection of preferred contacts for the central user are recommended by the query apparatus according to the input data received by the query apparatus that includes central user's communication patterns and situational factors. The recommended collection of preferred contacts can change dynamically based on the ongoing changing situational factors.

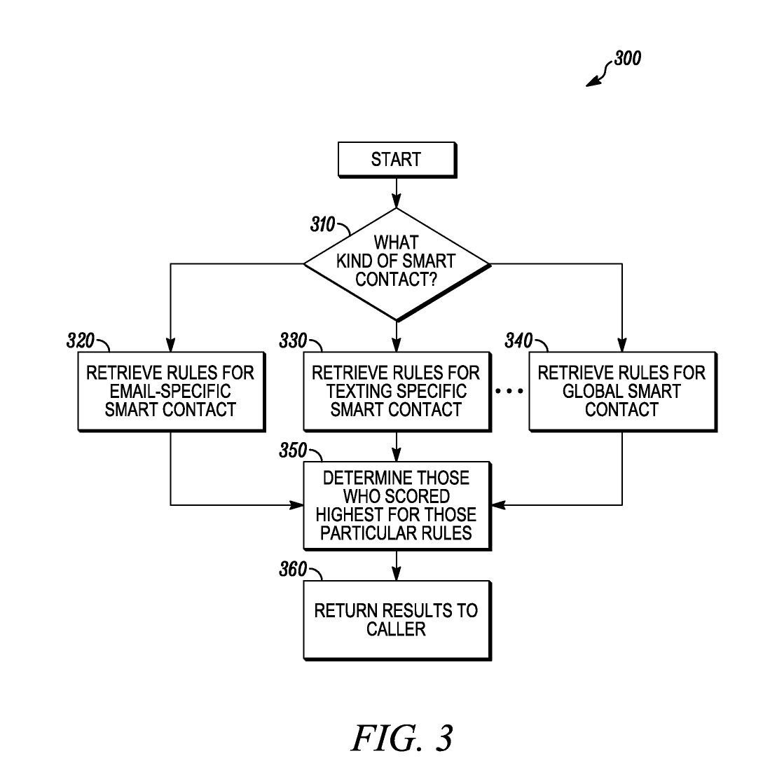

FIG. 3 illustrates an exemplary flowchart 300 depicting an example method used by a query apparatus for determining the most likely set of contacts for a central user at one particular moment in time. These most likely set of contacts can be thought of as “suggested contacts” or “smart contacts”, because they are preferable to the central user and have been inferred by the central user's habits prior to being suggested as a likely choice for the central user at a particular moment in time. A specific inquiry 300 inquires ‘what kind of smart contact is the central user interested in at this moment in time’. This inquiry may be answered by monitoring the application that the central user may be operating, such as email, text or a short messaging application, or a phone dialing application. Several likely alternatives are possible, including email contacts, texting contacts, and global contacts. However, this list is not exhaustive and further could include social networking contacts, for example. Depending on the kind of smart contact that the central user is interested in one or more rules may be retrieved that correspond to the application that the central user has launched. For example, operation 320 retrieves rules for email specific smart contacts. Operation 330 retrieves rules for texting specific smart contacts. Operation 340 retrieves rules for global specific smart contacts that may be used in more than one application and can be accessed from the general contacts application. Each rule may have an associated numerical point. For each person included in a mobile communication device address book, a “RuleChecker” determines whether that person passes a rule, such as “did the user of the mobile communication device recently email this person”. It is contemplated that the RuleChecker executes all rules for each person in the address book; however, subsets of persons may be used instead. Nevertheless, each checked person is assigned a point total. The point total is compared to a minimum total score threshold.

The type of smart contact may impact how many points are awarded for a particular rule. For example, if the rule is: “contacts that you will most likely email”; a subsequent corresponding rule of: “did you email him recently” may receive a greater number of points. Notably, various factors may be measured. For example, a) the number of phone calls, texts, or emails for a particular contact; b) the total number of phone calls, texts, or emails for a particular contact; c) the number of recent phone calls, texts, or emails for a particular contact; d) the number of phone calls, texts, or emails for a particular contact within 1-2 hours of the current time (on any day); e) whether the central user and the contact have mutually called, emailed, or texted one another (which is in sharp contrast to one-way communication from say a telemarketer); and f) whether a contact has been tagged by the central user as a favorite contact.

Operation 350 in FIG. 3 accepts the retrieved rules from operations 320, 330, and 340 before determining which application has scored the highest or the most points for one or more retrieved rule, or has either met or exceeded the minimum total score threshold. Of course other methods that may calculate points in another manner or that may give greater weight or importance to a preferred or smart contact may also be employed as well.

A working example is described herein in further detail on one example of a rule scoring system that may be employed. A background service may be triggered by an event such as a completed phone call. In the case of any time-based rules (e.g., “called contact within the past X hours”), a service may poll every X/2 hours. The polling method may employ Nyquist's sampling theorem, for example. Operation 360 returns the suggested or smart contact information to the central user in the form of a list or other graphical display, such as an icon or thumbnail image, for example. Results can be used to update a Sqlite3 database via the Suggestion ContentProvider in FIG. 1.

It has also been contemplated that the Operations 320, 330, 340 and 350 may behave differently depending on behavior of the central user (i.e., a User Persona) that is utilizing the device. For example, if the user exhibits behavior that shows affinity for and usage of social networking (e.g. posting status updates and sending social network messages), the Operations may be tweaked to provide results more appropriate for this user behavior (also referred to as Persona). If the central user instead exhibits behavior that shows he/she is more comfortable with traditional electronic communication methods (e.g. telephone calls), Operations 320-350 may be tweaked to provide results better aligned with this Persona.

This tweaking will happen during the usage of the MCD. The system can allow central users to switch among different Personas, depending on the user's observed behavior.

Specifically, Operation 320, 330 and 340 will retrieve a different set of rules, depending on the Persona. For example, if the Persona indicates that the central user is a heavy social network user, Operation 320 may not include rules that are related to traditional electronic communication methods, like telephone calls.

Therefore, not only does the set of rules change, but also the point weightings associated with each rule. Depending on the Persona, Operation 350 may attribute different weightings for each rule and calculate a point total based on these tweaked point weightings.

Suggested preferred contacts are designed to help the central user become more productive when creating email messages, text messages, social networking messages, or creating calendar events. Text messaging can include short messaging systems (SMS) and multi-media systems (MMS). Emails can include corporate email, ActiveSync, Post Office Protocol version 3 (POP3), and Internet Message Access Protocol (IMAP) email systems, for example. The more the central user interacts with a contact, the more likely that the contact will become a suggested preferred contact (i.e., Smart Contact). One or more embodiments may be implemented using email rules and text messaging rules (short messaging system, SMS). As the central user sends/receives more messages to her contacts, then those contacts accumulate points based on certain rules. If the number of points equal or exceed the threshold (e.g., Threshold=100), then they are candidates to appear as a Smart Contact. For illustration, email and text messaging point accumulation according to exemplary rules are described below.

### I. Email Rules

### Email Rule 1

Send an email to a Starred contact=60 points

### Email Rule 2

Send an email to a contact 3 times=60 points

These emails need to be sent 2 hours apart from each other for the contact to be assigned only 60 points (If 2 emails are sent within a 1-2 hour time block then an additional 60 points are assigned due to Rule 3)

### Email Rule 3 (aka Time Block Rule)

Send 2 emails to a contact within a 1-2 hour time block=60 points

(This is a Time Block Rule. It is a special rule because it keeps track of the time period the emails were sent. For instance, if you send 2 emails to a contact at 5 pm then that contact could appear as a smart contact the next day at 5 pm. I say that they “could” appear as a smart contact because all smart contacts need a score greater than the threshold which is 100.

### Email Rule 4

Send an email to a contact 6 times=40 points

These emails need to be sent 2 hours apart from each other for the contact to be assigned only 40 points (If 2 emails are sent within a 1-2 hour time block then an additional 60 points are assigned due to Rule 3)

### Email Rule 5

Receive 4 emails from a contact=30 points

### Email Rule 6 (aka Frequency Rule)

For each email sent to a contact then 1 point is assigned (emails received will not be counted). The maximum number of frequency points that may be accumulated is 10. This rule was created so some smart contacts would appear when a user first uses email. As the user sends and receives more email then this rule becomes less relevant.

### Email Example: (Effects New Email Messages and New Calendar Events)

Send an email to a starred contact (Rule 1) and that contact is assigned 60 points. The threshold is 100. Since 60<100 then this contact does not appear as a smart contact. The user would need to perform another action to accumulate more points to break through the 100 threshold. For instance they could send a second email to the same contact within a 1-2 hour period (Rule 3) then this contact would accumulate another 60 points plus Frequency points. The following illustrates the points assigned in this example:
Send an email to a starred contact=60 points
Threshold is 100. Since 60<100 then this contact will Not appear as a Smart Contact
Send a second email within a 1-2 hour time block=60 points
Since two emails were sent, the Frequency rule adds another 2 points=2 points
Total=60+60+2=122
Threshold is 100. Since 122>100 then this contact is a candidate to appear as a Smart Contact

When the user creates a new message the cursor appears in the To: and a dropdown should automatically display the top 3 Smart Contacts. These are usually Smart Contacts with the highest score. If a time block rule applies (Rule 3) then the contact will appear in the appropriate time block. When the user creates a new calendar event, select the appropriate calendar, go to the “Who” field and a dropdown should automatically display the same Smart Contacts.

### II. Text Messaging

### Text Message Rule 1

Send a text message to a Starred contact=60 points

### Text Message Rule 2

Send text message to a contact 3 times=60 points

These text messages need to be sent 2 hours apart from each other for the contact to be assigned only 60 points (If 2 text messages are sent within a 1-2 hour time block then an additional 60 points are assigned due to Rule 3)

### Text Message Rule 3 (aka Time Block Rule)

Send 2 text messages to a contact within a 1-2 hour time block=60 points

(This is a Time Block Rule. It is a special rule because it keeps track of the time period the emails were sent. For instance, if you send 2 text messages to a contact at 5 pm then that contact could appear as a smart contact the next day at 5 pm. I say that they “could” appear as a smart contact because all smart contacts need a score greater than the threshold which is 100.

### Text Message Rule 4

Send a text message to a contact 6 times=40 points

These text messages need to be sent 2 hours apart from each other for the contact to be assigned only 40 points (If 2 text messages are sent within a 1-2 hour time block then an additional 60 points are assigned due to Rule 3)

### Text Message Rule 5

Receive 4 text messages from a contact=30 points

### Text Message Rule 6 (aka Frequency Rule)

For each text message sent to a contact or received from a contact then 1 point is assigned (this is different from email where only messages sent are assigned 1 point). The maximum number of frequency points that may be accumulated is 10. This rule was created so some smart contacts would appear when a user first uses text messaging. As the user sends and receives more text messages then this rule becomes less relevant.

### Text Message Example:

Send 3 text messages to a contact (Rule 1). For instance send one text message at 8 am, another text message at 11 am and then a third text message at 2 pm. The contact is assigned 60 points. The threshold is 100. Since 60<100 then this contact does not appear as a smart contact. Send 3 more text messages, 2 hours apart so now you have text messaged the same user 6 times (Rule 4). Now they are assigned another 40 points. 60+40=100 plus Frequency points. The following illustrates the points assigned in this example:
Send 3 text messages to a contact (2 hours apart)=60 points
Threshold is 100. Since 60<100 then this contact will Not appear as a Smart Contact
Send 3 more text messages to the same contact (2 hours apart)=40
Since 6 text messages were sent, the Frequency rule adds another 6 points=6 points
Total=60+40+6=106
Threshold is 100. Since 106>100 then this contact is a candidate to appear as a Smart Contact

When the user creates a new text message the cursor appears in the To: and a dropdown should automatically display the top 3 Smart Contacts. These are usually Smart Contacts with the highest score. If a time block rule applies (Rule 3) then the contact will appear in the appropriate time block.

### III. Global Smart Contacts

Global Contacts appear in the Favorites tab. Global Contacts are derived using a combination of the Mail Rules, Text Messaging Rules and Dialer Rules (aka Phone Rules).

1. Email Rules are the same as described above
2. Text Messaging Rules are the same as described above
3. Dialer Rules (aka Phone Rules are only used for Global Smart Contacts)

### Dialer Rule 1

Call a Starred contact=60 points

### Dialer Rule 2

Call a contact and receive/answer a call from the same contact=60 points

### Dialer Rule 3

Receive/answer a call within the past 3 hours=60 points

### Dialer Rule 4

Call a contact 3 times=60 points

### Dialer Rule 5 (aka Time Block Rule)

Call a contact 2 times within a 1-2 hour period=60 points

(Note: you will see this contact at the same time on different days)

### Dialer Rule 6

Call a contact 6 times=40 points

### Dialer Rule 7

Receive/answer a call from a contact 4 times=30 points

### Dialer Rule 8 (aka Frequency Rule)

For each outbound call to a contact or received/answered call from a contact then 1 point is assigned. The maximum number of frequency points that may be accumulated is 10.

### Global Smart Contact Example:

A user calls a contact 3 times (60 points), sends an email to a starred contact (60 points), text messages the same person 3 times where each email was sent 2 hours apart from each other (60 points) then this total is 180 points. Add 6 frequency points so the Total is 186. Since 186>100 threshold, it is a candidate for displaying as a Smart Contact in the Favorites tab.

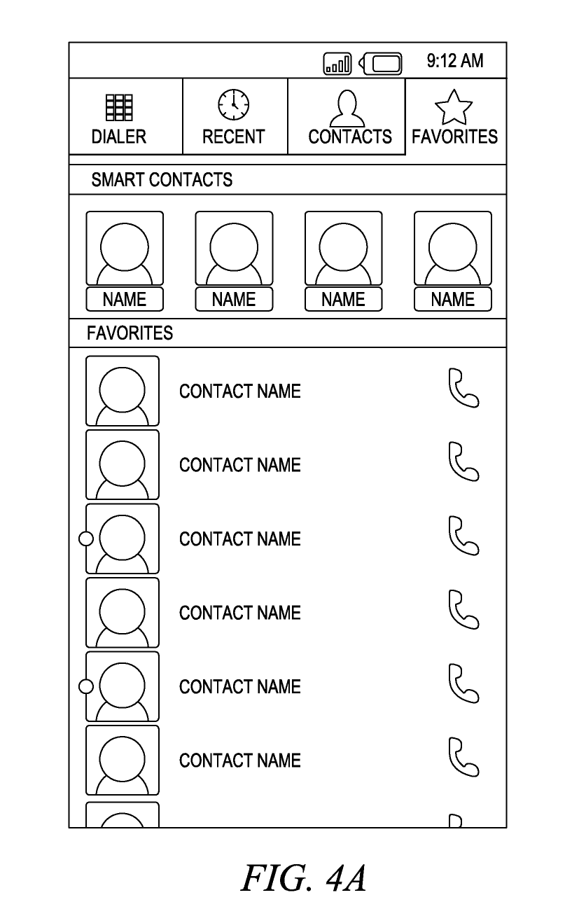

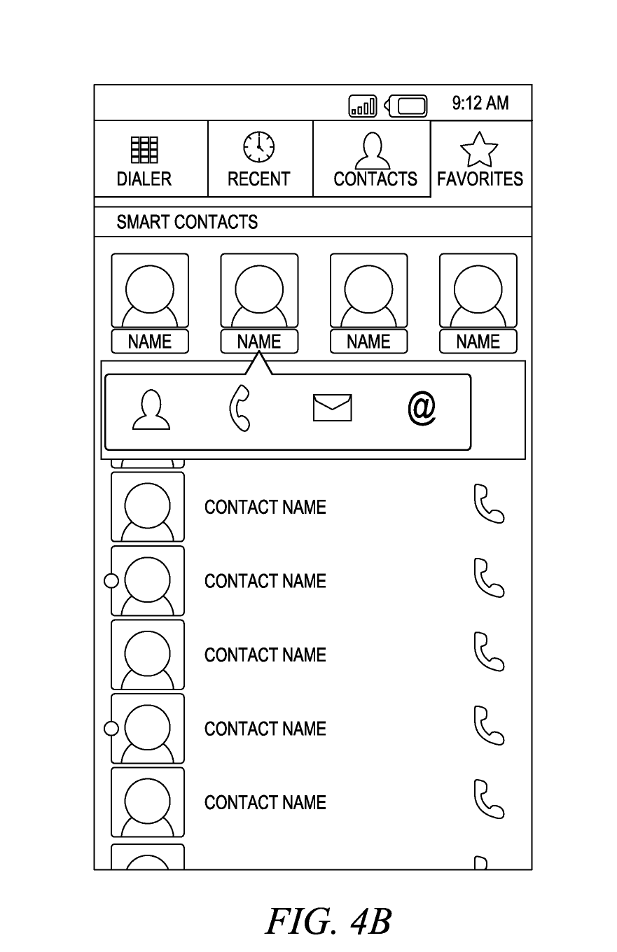

FIG. 4A illustrates an example screenshot for a mobile communication device that shows a method of accessing a collection of global preferred contacts for the central user of the mobile communication device. The favorite tab of the graphical display screen has been selected. Consequently, several favorite contact names are listed and can be selected. These favorite contact names can be several scores of contact names, (i.e., multiples of twenty), from a contact list of several hundred contact names. In addition, there is a segment or subset of the display of contacts that are preferred to the central user and are considered as smart contacts herein. These suggested or preferred smart contacts can be favorite contacts, but may not be as well. These smart contacts can be displayed as thumbnail images or other icons, or as a simple list. When the central user selects one of the smart contacts the smart contact can be used in more than one mobile communication device application, for example, phone dialing, texting, or emailing.

FIG. 4B illustrates that one smart contact has been selected and has the option to be communicated with via a contact detail screen, phone dialer, text messaging, or email or social networking messaging. In general, when the central user launches a contacts application, the preferred global contacts are easily accessible at the top of the list; thereby avoiding a long exhaustive search through hundreds of possible contact names.

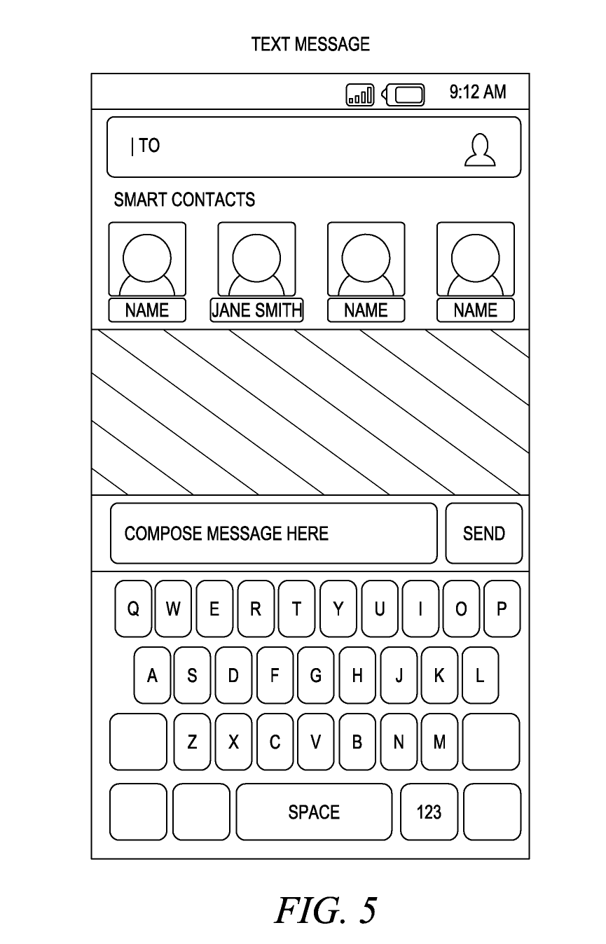

FIG. 5 illustrates an example screenshot for a text messaging specific application. In this text messaging example, the central user can compose a text message in the “compose message’ box and be presented with several preferred or smart contacts on her mobile communication device display screen for possible addressees or recipients of the finished text message. These smart contacts can be displayed as thumbnail images or other icons, or as a simple list.

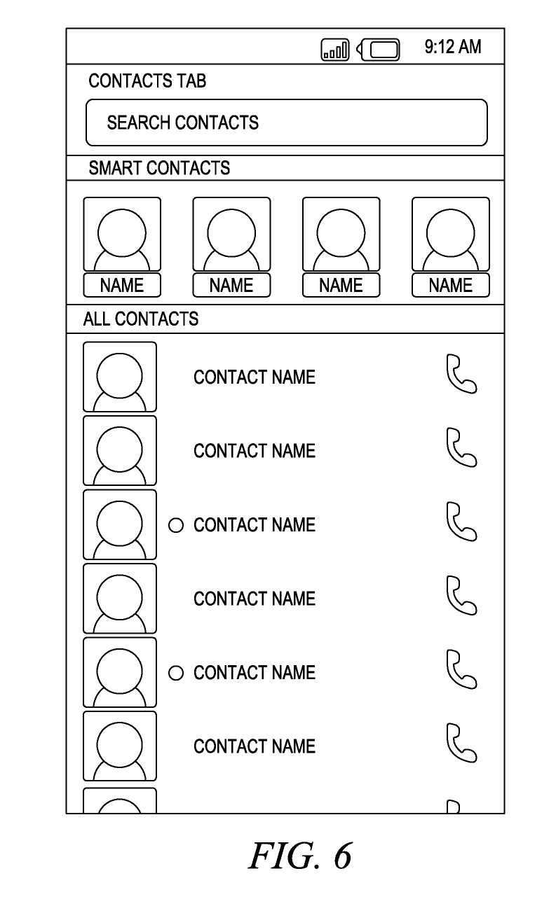

FIG. 6 illustrates an example screenshot for a mobile communication device that shows a method of accessing a collection of global preferred contacts for the central user of the mobile communication device. The contacts tab of the graphical display screen has been selected. Consequently, several contact names are listed and can be selected from perhaps hundreds or more contacts that the central user may periodically interact with or acquire over her lifetime. FIG. 6 depicts an alternative to FIG. 4A in which the “Favorites” tab had been selected by the central user. In FIG. 6, the full contacts list is displayed by selecting the “Contacts” tab.

There is a segment or subset of the display of contacts that are preferred to the central user and are considered as global smart contacts within the Contacts application of the mobile communication device. These smart contacts can be displayed as thumbnail images or other icons, or as a simple list. When the central user selects one of the smart contacts the smart contact can be used in more than one mobile communication device application, for example, phone dialing, texting, or emailing.

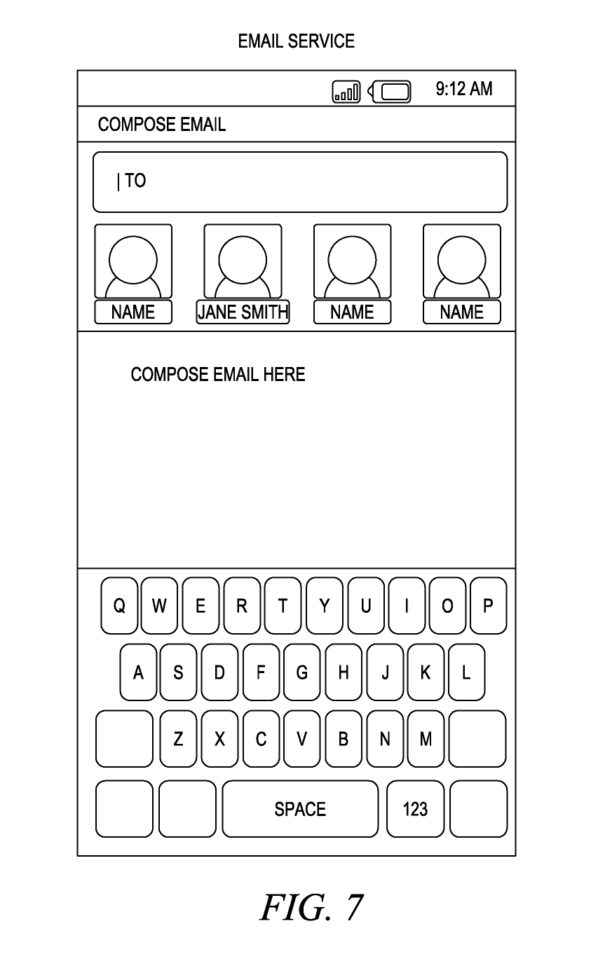

FIG. 7 illustrates an example screenshot for an email messaging specific application. In this email messaging example, the central user can compose an email message in the “compose message’ box or area and be presented with several preferred or smart contacts on her mobile communication device display screen for possible addressees or recipients of the finished email message. The area for email composition may be three-fold larger than the compose message area for a text messaging application. The suggested or preferred smart contacts can be displayed as thumbnail images or other icons, or as a simple list. The smart contacts for the text messaging application and the email messaging application may differ.

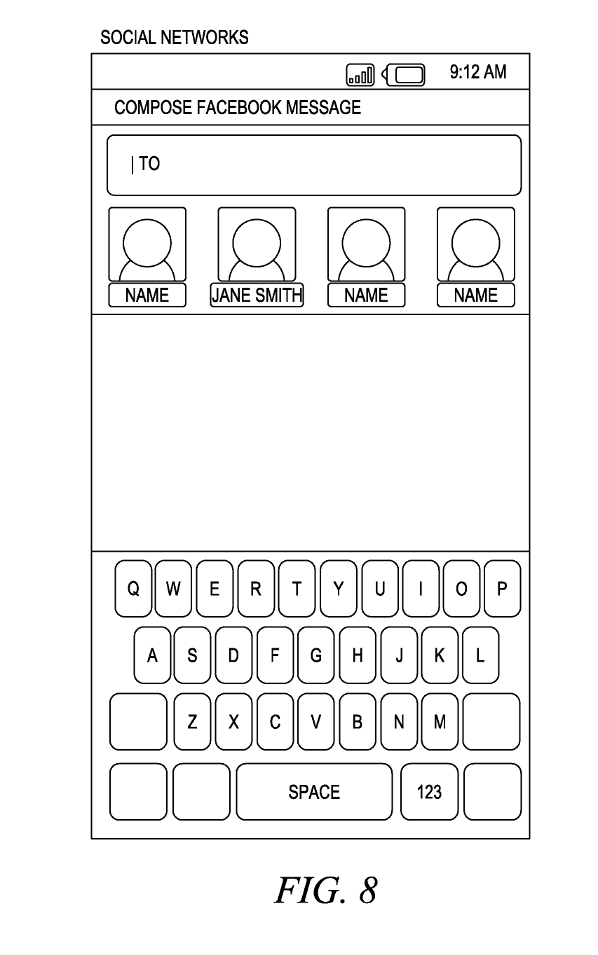

FIG. 8 illustrates an example screenshot for a social media networking specific application. In this social media networking example, the central user can compose a message in the “compose message’ box or area and be presented with several preferred or smart contacts on her mobile communication device display screen for possible addressees or recipients of the finished message. The area for composition may be three-fold larger than the compose message area for a text messaging application. The suggested or preferred smart contacts can be displayed as thumbnail images or other icons, or as a simple list. The smart contacts may differ for each of the social media networking, text messaging application and the email messaging application.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

Furthermore, although individually listed, a plurality of means, elements or method steps may be implemented by a single processor or controller, for example. Additionally, although individual features may be included in different claims, these may possibly be advantageously combined, and the inclusion in different claims does not imply that a combination of features is not feasible or advantageous. Also, the inclusion of a feature in one category of claims does not imply a limitation to this category, but rather indicates that the feature is equally applicable to other claim categories as appropriate. Notably, the order of features in the claims does not imply any specific order in which the features must be worked and in particular the order of individual steps in a method claim does not imply that the steps must be performed in the listed order. Consequently, the steps may be performed in any suitable operational order.

We claim:

1. A system implemented on a mobile communication device for establishing preferred contacts for a central user of the mobile communication device, comprising:
a data collection device that captures the central user's interaction with other users on a network according to frequency during situational factors;
a query apparatus that inquires, for current situational factors, which contacts are preferred that the central user will communicate with based on central user's past interactions during same situational factors that correspond only to the central user;
a list provided to the central user of one or more of the preferred contacts that the central user selects from; and
an application launcher that is communicatively coupled to the list for display of the list of preferred contacts that are also functionally related to the application launcher.

2. The system according to claim 1, wherein the situational factors include time of day, day of week, geographical location, seasonal period, an electronic calendar of the central user, and electronic devices in proximity to the central user's mobile communication device.

3. The system according to claim 1, wherein the application launcher determines which application that the central user has launched, said application includes one or more short messaging systems, email systems, calling systems, social-networking messaging systems, instant messaging systems, and multi-media systems.

4. The system according to claim 1, wherein the situational factors degrade and the displayed preferred contacts dynamically change to a different display of preferred contacts.

5. The system according to claim 1, wherein the list of preferred contacts that are also functionally related to the application launcher are determined according to frequency of communication contact within an application launched by the application launcher.

6. A method for determining a most likely set of contacts for a central user of a mobile communication device at one particular moment in time, comprising the steps of:
inquiring what kind of preferred contact the central user is attempting to reach via the central user launching a mobile communication application;
retrieving rules that correspond to the launched mobile communication application and that are based on central user's past interactions during same situational factors that correspond only to the central user;
calculating a rule point total and comparing the rule point total to a predetermined threshold;
determining those rules that meet or exceed the threshold; and
displaying the set of preferred contacts to the central user on the mobile communication device.

7. The method according to claim 6, wherein the situational factors include time of day, day of week, geographical location, seasonal period, an electronic calendar of the central user, and electronic devices in proximity to the central user's mobile communication device.

8. The method according to claim 6, wherein the launched mobile communication application includes one or more short messaging systems, email systems, calling systems, social-networking messaging systems, instant messaging systems, multi-media systems.

9. The method according to claim 6, where the situational factors degrade and the displayed preferred contacts dynamically change.

10. A non-transitory machine readable storage device, having stored thereon a computer program that include a plurality of code sections comprising:
code for inquiring what kind of preferred contact the central user is attempting to reach via the central user launching a mobile communication application;
code for retrieving rules that correspond to the launched mobile communication application and that are based on central user's past interactions during same situational factors that correspond only to the central user;
code for calculating a rule point total and comparing the rule point total to a predetermined threshold;
code for determining those rules that meet or exceed the threshold; and
code for displaying the set of preferred contacts to the central user on the mobile communication device.

11. The non-transitory machine readable storage device according to claim 10, wherein the situational factors include time of day, day of week, geographical location, seasonal period, an electronic calendar of the central user, and electronic devices in proximity to the central user's mobile communication device.

12. The non-transitory machine readable storage device according to claim 10, wherein the launched mobile communication application includes one or more short messaging systems, email systems, calling systems, social-networking messaging systems, instant messaging systems, multi-media systems.

13. The non-transitory machine readable storage device according to claim 10, where the situational factors degrade and the displayed preferred contacts dynamically change.
